(19) United States
(12) Patent Application Publication
(10) Pub. No.: US 2012/0250826 A1
(43) Pub. Date: Oct. 4, 2012

(54) RADIOGRAPHIC IMAGING APPARATUS

(75) Inventors: Tetsuo Watanabe, Utsunomiya-shi (JP); Hidetomo Suwa, Machida-shi (JP); Takahiro Koyanagi, Kawasaki-shi (JP)

(73) Assignee: CANON KABUSHIKI KAISHA, Tokyo (JP)

(21) Appl. No.: 13/512,286

(22) PCT Filed: Nov. 18, 2010
(86) PCT No.: PCT/JP2010/006771

§ 371 Date: May 25, 2012

(30) Foreign Application Priority Data
Nov. 27, 2009 (JP) 2009-270095

(51) Int. Cl. H05G 1/64

(52) U.S. Cl. 378/98

(57) ABSTRACT

A radiographic imaging apparatus includes a radiation detection unit configured to detect radiation that has passed through an object, a protection member capable of being detachably attached to the radiation detection unit to protect the radiation detection unit, a first display unit disposed on the radiation detection unit and configured to display a state of the radiation detection unit, and a second display unit disposed on the protection member and configured to display the state of the radiation detection unit in accordance with a display of the first display unit when the protection member is attached to the radiation detection unit.

### TECHNICAL FIELD

The present invention relates to a radiographic imaging apparatus including a radiation detection unit that detects radiation.

### BACKGROUND ART

Apparatuses that obtain a radiographic image by irradiating an object with radiation and detecting an intensity distribution of the radiation that has passed through the object are commonly used in the field of industrial non-destructive inspection and medical field. Such an apparatus generally uses a film/screen method or a computed radiography (CR) method. In these methods, a photosensitive film that is sensitive to the radiation or a fluorescent plate that bears an image as a latent image is used in an imaging operation while the photosensitive film or the fluorescent plate is placed in a casing called a cassette. In the case where the cassette is used, it is necessary to position the object and the cassette at desired positions in the imaging operation. Therefore, Japanese Patent Laid-Open No. 10-282598 proposes a cassette carrier that contains a cassette at a central section thereof and that has grip portions at either side thereof.

Recently, a portable radiographic imaging apparatus that uses a digital radiography (DR) method in which a radiographic image is captured using a semiconductor sensor and is digitized has been developed and put into practical use.

The radiographic imaging apparatus using the DR method includes a large number of electronic components. Therefore, although the weight of the apparatus has been reduced, the apparatus is still heavier than the apparatus according to the related art that uses the cassette. Japanese Patent No. 3577003 discloses a radiographic imaging apparatus using the DR method that is provided with a handle to be grabbed to ensure the portability of the apparatus.

In the case where a radiographic imaging operation is performed by the radiographic imaging apparatus using the DR method disclosed in Japanese Patent No. 3577003, it is necessary to check the imaging condition, the remaining power of a battery in the radiographic imaging apparatus, and the like.

Therefore, in the radiographic imaging apparatus according to the related art, a display unit for displaying the state of the radiographic imaging apparatus is provided on, for example, a side surface of a housing of the apparatus.

However, since the portable radiographic imaging apparatus is used in various applications, there is a possibility that the visibility of the display unit will be reduced.

For example, in the case where side surfaces of the radiographic imaging apparatus are reinforced by a reinforcing member, there is a possibility that the display unit will be covered by the reinforcing member.

### CITATION LIST

### Patent Literature

PTL 1: PTL 1: Japanese Patent Laid-Open No. 10-282598

PTL 2: Japanese Patent No. 3577003

### SUMMARY OF INVENTION

The present invention has been made in consideration of the above situation, and provides a radiographic imaging apparatus capable of ensuring the visibility of a display unit that displays the state of the radiographic imaging apparatus.

According to the present invention, a radiographic imaging apparatus includes a radiation detection unit configured to detect radiation that has passed through an object; a protection member capable of being detachably attached to the radiation detection unit to protect the radiation detection unit; a first display unit disposed on the radiation detection unit and configured to display a state of the radiation detection unit; and a second display unit disposed on the protection member and configured to display the state of the radiation detection unit in accordance with a display of the first display unit when the protection member is attached to the radiation detection unit.

Other features and advantages of the present invention will be apparent from the following description taken in conjunction with the accompanying drawings, in which like reference characters designate the same or similar parts throughout the figures thereof.

### BRIEF DESCRIPTION OF DRAWINGS

The accompanying drawings, which are incorporated in and constitute a part of the specification, illustrate embodiments of the invention and, together with the description, serve to explain the principles of the invention.

FIG. 1 is a diagram illustrating the structure of a radiographic imaging apparatus according to a first embodiment.

FIG. 2 is a sectional view of the inner structure of the radiographic imaging apparatus according to the first embodiment in which a radiographic detection unit is attached to a handle unit.

FIG. 3 is a diagram illustrating the external view of a radiographic imaging apparatus according to a second embodiment.

FIG. 4 is a sectional view of the radiographic imaging apparatus according to the second embodiment taken along a plane perpendicular to a radiation incidence axis.

FIG. 5 is a diagram illustrating the external view of a radiographic imaging apparatus according to a third embodiment.

### DESCRIPTION OF EMBODIMENTS

Preferred embodiments of the present invention will be described in detail in accordance with the accompanying drawings.

### First Embodiment

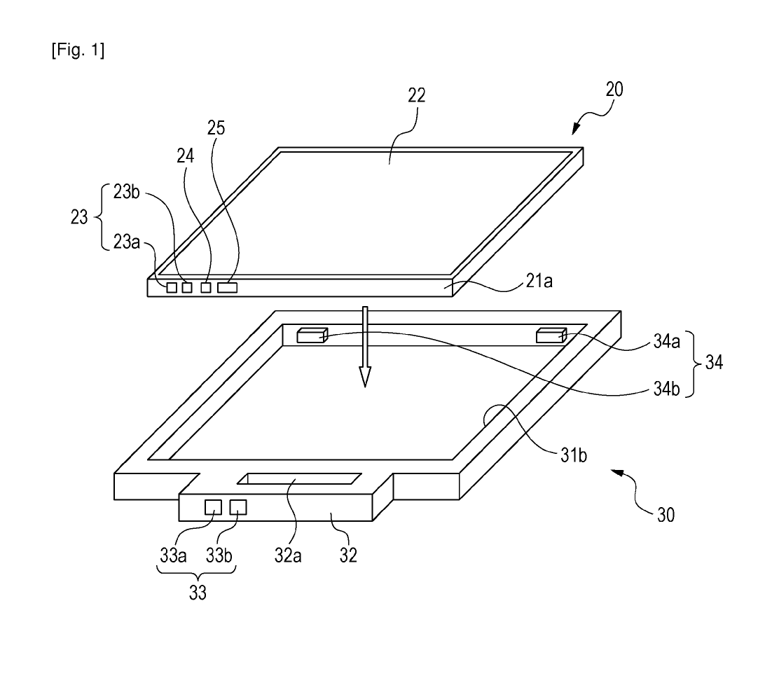

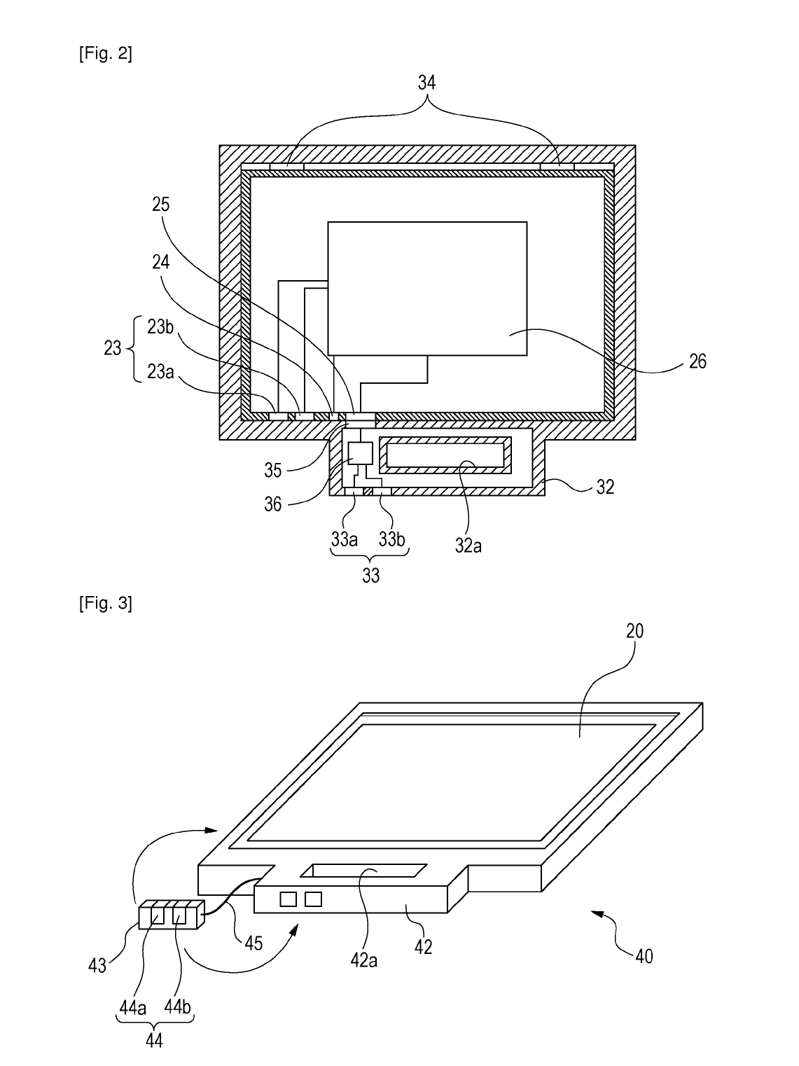

The structure of a radiographic imaging apparatus according to a first embodiment will be described with reference to FIGS. 1 and 2. FIG. 1 mainly illustrates a radiation detection unit included in the radiographic imaging apparatus. However, in general, the radiographic imaging apparatus also includes a radiation emitting device that emits radiation and a radiation imaging control device that controls the radiation emitting device and the radiation detection unit. Explanations of the radiation emitting device and the radiation imaging control device are omitted in the following description.

FIG. 1 illustrates two units included in the radiographic imaging apparatus according to the present embodiment. A radiation detection unit 20 detects the radiation that has passed through an object and obtains a radiographic image. The radiation detection unit 20 is one of the two units included in the radiographic imaging apparatus, and is structured as described below.

The radiation detection unit 20 includes a radiation detection surface 22. The radiographic imaging apparatus detects radiation that is incident on the radiation detection surface 22. The radiation detection surface 22 is provided with photoelectric conversion elements that convert the radiation into visible light and converters that convert the visible light into electric signals.

The radiation detection unit 20 has a rectangular parallelepiped shape, and a first display unit 23 for displaying the state of the radiation detection unit 20 is provided on a side surface 21a of the radiation detection unit 20. The first display unit 23 includes a plurality of display elements 23a and 23b, such as light-emitting diodes (LEDs), which can be turned on, and is capable of displaying various states of the radiation detection unit 20. Information that can be displayed includes, for example, the remaining power of a battery included in the radiation detection unit 20 and information indicating a standby state or a driving state. For example, the display element 23b can be turned on when the radiographic imaging apparatus is in a standby state and be flashed when the radiographic imaging apparatus is in operation. In addition, for example, the brightness of the display element 23a can be changed in accordance with the remaining power of the battery.

A blockage detector 24 is a light detector that detects external light, and has a function of detecting whether or not the side surface 21a is blocked by an object.

A transmitter 25 transmits display information that is displayed on the display unit 23 to the outside by, for example, infrared communication.

Next, another one of the two units included in the radiographic imaging apparatus will be described.

A handle unit 30 has a recess 31b capable of accommodating the radiation detection unit 20, and functions as a protection member for protecting the radiation detection unit 20 disposed in the recess 31b from, for example, an externally applied impact. The handle unit 30 serves to increase the portability of the radiation detection unit 20.

The handle unit 30 has the following structure.

That is, the handle unit 30 includes a grip portion 32 that can be gripped to hold the radiation detection unit 20. The grip portion 32 has a hollow section 32a.

A second display unit 33 displays information received from the outside in synchronization with the display of the first display unit 23. The second display unit 33 has a structure similar to that of the first display unit 23, and includes a plurality of display elements 33a and 33b.

As illustrated in FIG. 2, the second display unit 33 is disposed on the grip portion 32.

A securing unit 34 includes leaf springs or the like and urges the radiation detection unit 20 disposed in the recess 31b to secure the radiation detection unit 20 to the handle unit 30. The securing unit 34 includes a plurality of urging units 34a and 34b to stably secure the radiation detection unit 20.

FIG. 2 is a sectional view of the inner structure of the radiographic imaging apparatus in which the radiographic detection unit 20 is accommodated in the handle unit 30. The sectional view shown in FIG. 2 is taken along a plane perpendicular to an incidence axis of the radiation incident on the radiation detection unit 20. In FIG. 2, the radiation detection unit 20 is urged by the securing unit 34 and is retained in the recess 31b.

The structures of components of the radiographic imaging apparatus illustrated in FIG. 2 will now be described.

A control circuit 26 detects the state of the radiographic imaging apparatus (the remaining power of the battery, information indicating a standby state or a driving state, etc.) and controls the first display unit 23, the blockage detector 24, and the transmitter 25 on the basis of the result of the detection. The control circuit 26 includes an integrated circuit or the like that is capable of performing control processes, and functions as a control unit.

A receiver 35 receives infrared signals transmitted from the transmitter 25. The receiver 35 is disposed so as to face the transmitter 25 when the radiation detection unit 20 is mounted to the handle unit 30.

An electric circuit 36 processes the information received by the receiver 35. The electric circuit 36 includes an integrated circuit or the like that is capable of performing information processing, and functions as a second control unit.

The components of the radiographic imaging apparatus according to the present embodiment have the above-described structures. The processes performed by the components according to the present embodiment will now be described.

As described above, the first display unit 23 displays the state of the radiographic imaging apparatus. However, when the radiation detection unit 20 is mounted to the handle unit 30, the display of the first display unit 23 is covered by the handle unit 30. Whether or not the display of the first display unit 23 is covered can be determined by the blockage detector 24. Therefore, in the radiographic imaging apparatus according to the present embodiment, when the blockage detector 24 detects that the side surface 21a is blocked, the second display unit 33 displays the state of the radiographic imaging apparatus in synchronization with the first display unit 23. More specifically, first, the control circuit 26 receives a signal indicating that the side surface 21a is blocked from the blockage detector 24. After the signal is received, the control circuit 26 stops the display of the first display unit 23 and causes the transmitter 25 to transmit an infrared signal indicating that the side surface 21a is blocked. The receiver 35 receives the infrared signal, and transmits the signal to the electric circuit 36. The electric circuit 36 causes the second display unit 33 to display the state of the radiographic imaging apparatus in synchronization with the first display unit 23.

With the above-described process, even when the display of the first display unit 23 is blocked by the handle unit 30, the state of the radiographic imaging apparatus can be visually checked through the second display unit 33. In addition, since the second display unit 33 is disposed on the grip portion 32 that projects from the radiographic imaging apparatus, the possibility that the display will be blocked by the object or the like is low. In addition, since the grip portion 32 is conspicuous to the user, the visibility of the display can be ensured. Thus, according to the radiographic imaging apparatus of the present embodiment, the visibility of the display unit that displays the state of the radiographic imaging apparatus can be ensured. In addition, according to the present embodiment, the handle unit 30 is formed so as to surround the side surfaces of the radiation detection unit 20, and the second display unit 33 is provided on the grip portion 32. Therefore, the radiation detection unit 20 can be reinforced and the visibility of the display of the state of the radiographic imaging apparatus can be increased.

When the portable radiographic imaging apparatus is carried, there is a risk that the radiographic imaging apparatus will be dropped or struck against an object. Therefore, the handle unit 30 serves to effectively protect the radiation detection unit 20, which is expensive. In particular, in the case where a user visits a subject to carry out the imaging operation while the subject lies on a bed, the radiation detection unit is often placed under the subject. However, even when a load is applied to the radiation detection unit, the radiation detection unit can bear the load since a back plate portion is provided at the back side thereof.

In the present embodiment, the blockage detector 24 and the electric circuit 36 are used to detect whether or not the radiation detection unit 20 is mounted to the handle unit 30. However, the blockage detector 24 and the electric circuit 36 may be omitted, and a light-guiding portion that guides light from the first display unit 23 may be provided on the handle unit 30. The light-guiding portion is a hole formed in an inner section of the handle unit 30, and the inner section may be formed of a mirror surface that easily guides the light from the first display unit 23. In the case where the light-guiding portion is provided, the display synchronized with the first display unit 23 can be presented without using the blockage detector 24 and the electric circuit 36. In addition, as described above, in the present embodiment, the display of the second display unit 33 is presented when it is determined by the blockage detector 24 that the display of the first display unit 23 is blocked. However, it can be determined, for example, whether the radiation detection unit 20 is mounted to the handle unit 30, and the display of the second display unit 33 can be presented when it is detected that the radiation detection unit 20 is mounted to the handle unit 30 irrespective of whether or not the display of the first display unit 23 is blocked.

### Second Embodiment

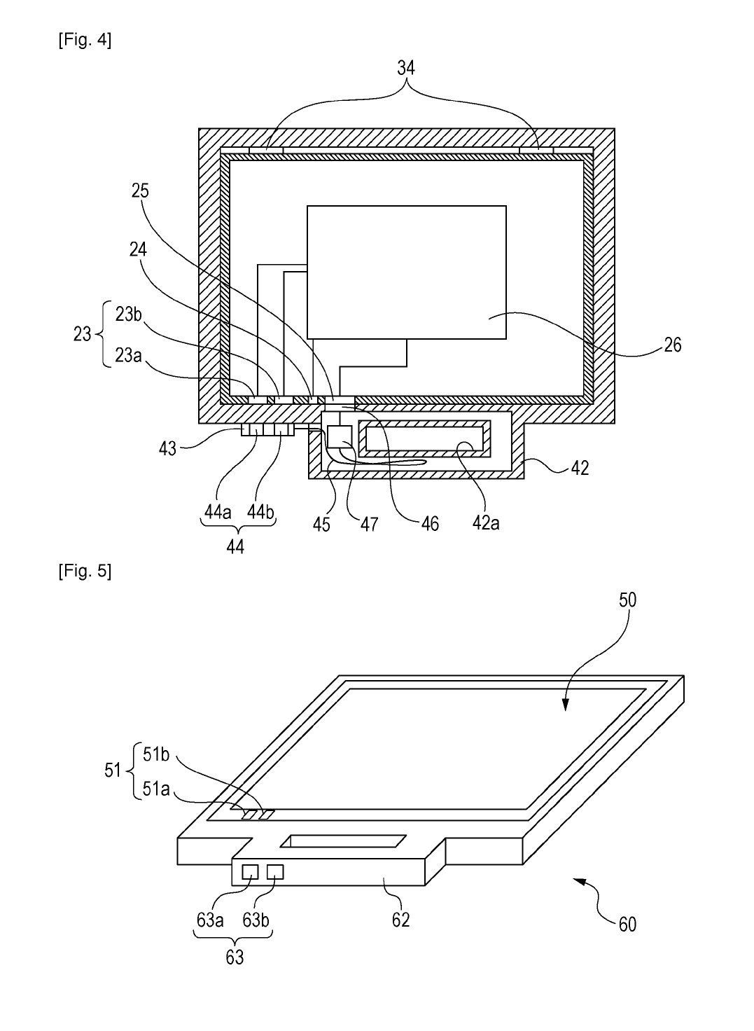

Next, a second embodiment will be described with reference to FIGS. 3 and 4.

FIG. 3 is a diagram illustrating the external view of a radiographic imaging apparatus according to the present embodiment. This radiographic imaging apparatus differs from the radiographic imaging apparatus according to the first embodiment in that a second display unit 44 that is synchronized with the first display unit 23 is detachable. The second display unit 44 includes a plurality of display elements 44a and 44b and is detachable from a handle unit 40.

FIG. 4 is a sectional view of the radiographic imaging apparatus according to the present embodiment taken along a plane perpendicular to a radiation incidence axis. As illustrated in FIG. 4, a receiver 46 corresponds to the receiver 35 according to the first embodiment, and an electric circuit 47 corresponds to the electric circuit 36 according to the first embodiment.

The detachable second display unit 44 is provided on a separable display unit 43, and is connected to the electric circuit 47 by a cable 45. The cable 45 can be pulled out from or be stored in a grip portion 42. When the cable 45 is pulled out from the grip portion 42, the detachable second display unit 44 can be placed at a position separated from the handle portion 40.

According to the radiographic imaging apparatus of the present embodiment, the display unit can be moved to a position where the display unit that can be easily viewed in accordance with the manner in which the imaging operation is performed.

### Third Embodiment

FIG. 5 is a diagram illustrating the external view of a radiographic imaging apparatus according to a third embodiment. The radiographic imaging apparatus includes a radiation detection unit 50 and a handle unit 60. As illustrated in FIG. 5, a first display unit 51 is disposed on a radiation incident surface of the radiation detection unit 50 according to the present embodiment. Similar to the other embodiments, a second display unit 63 that is synchronized with a first display unit 51 is provided on a grip portion 62 of the handle unit 60. The first display unit 51 and the second display unit 63 include a plurality of display elements 51a and 5b and a plurality of display elements 63a and 63b, respectively, and display the state of the radiographic imaging apparatus in synchronization with each other. In the present embodiment, since the first display unit 51 and the second display unit 63 operate in synchronization with each other, the visibility of the display can be ensured in various states of operation.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-270095, filed Nov. 27, 2009, which is hereby incorporated by reference herein in its entirety.

1. A radiographic imaging apparatus comprising:
a radiation detection unit configured to detect radiation that has passed through an object;
a protection member capable of being detachably attached to the radiation detection unit to protect the radiation detection unit;
a first display unit disposed on the radiation detection unit and configured to display a state of the radiation detection unit for a user; and
a second display unit disposed on the protection member and configured to display the state of the radiation detection unit in accordance with a display of the first display unit when the protection member is attached to the radiation detection unit for the user.

2. The radiographic imaging apparatus according to claim 1, further comprising a blockage detector configured to detect whether the display of the first display unit is blocked, and
wherein the protection member includes a control unit that causes the second display unit to display the state of the radiation detection unit when the blockage detector detects that the display of the first display unit is blocked.

3. The radiographic imaging apparatus according to claim 2, wherein the radiation detection unit includes a second control unit that stops the display of the first display unit when the blockage detector detects that the display of the first display unit is blocked.

4. The radiographic imaging apparatus according to claim 1, wherein the second display unit is capable of being detachably attached to the protection member.

5. The radiographic imaging apparatus according to claim 1, wherein the radiation detection unit has a rectangular parallelepiped shape, and
wherein the protection member has a recess capable of accommodating the radiation detection unit so as to surround side surfaces of the radiation detection unit.

6. The radiographic imaging apparatus according to claim 1, wherein the state of the radiographic imaging apparatus includes at least one of remaining power of a battery included in the radiation detection unit, information indicating a driving state of the radiation detection unit, and information indicating a standby state of the radiation detection unit.

7. The radiographic imaging apparatus according to claim 1, wherein the display of the first display unit and a display of the second display unit are synchronized with each other.

8. (canceled)

9. A radiographic imaging apparatus that is capable of being attached to a protection member, the radiographic imaging apparatus comprising:
a radiation detection unit configured to detect radiation that has passed through an object;
a display unit that displays a state of the radiographic imaging apparatus for a user; and
a transmitter that transmits information corresponding to a display of the display unit to the protection member when the radiographic imaging apparatus is attached to the protection member so that the user can see the state of the radiographic imaging apparatus.

10. The radiographic imaging apparatus according to claim 1, further comprising a detector configured to detect whether or not at least the side surface of the radiation detection unit is blocked by an object; and
a control unit that causes the second display unit to display the state of the radiation detection unit when the detector detects that at least the specific area of the side surface of the radiation detection unit is blocked.

11. The radiographic imaging apparatus according to claim 1, further comprising a detector configured to detect whether or not the radiation detection unit and the protection member are attached together; and
a control unit that causes the second display unit to display the state of the radiation detection unit when the detector detects that the radiation detection unit and the protection member are attached together.

12. The radiographic imaging apparatus according to claim 1, wherein the protection member includes a grip portion, and
the second display unit is disposed on the grip portion.

13. The radiographic imaging apparatus according to claim 1, wherein the protection member includes a plurality of urging means for stably securing the radiation detection unit.

14. The radiographic imaging apparatus according to claim 1, further comprising a transmitter configured to transmit information corresponding to a display of the first display unit to the protection member when the radiographic detection unit is attached to the protection member.

15. The radiographic imaging apparatus according to claim 14, wherein the transmitter transmits an infrared signal indicating the information.

16. The radiographic imaging apparatus according to claim 1, further comprising a cable via which the second display unit is connected to the protection member.

17. The radiographic imaging apparatus according to claim 1, wherein the first display unit is disposed on a radiation incident surface of the radiation detection unit.

18. A method for controlling a radiographic imaging system, comprising:
displaying, by a display unit, information indicating a state of a radiation detection unit;
detecting a attachment of the radiation detection unit and a protection member;
causing a second display unit of the radiation detection unit to display the information in accordance with the detection.
